(19) United States
(12) Patent Application Publication
(10) Pub. No.: US 2015/0288468 A1
(43) Pub. Date: Oct. 8, 2015

(54) INFORMATION INTERACTION METHOD AND SYSTEM FOR ELECTRONIC CIGARETTES

(71) Applicant: Zhiyong Xiang, Shenzhen (CN)

(72) Inventor: Zhiyong Xiang, Shenzhen (CN)

(21) Appl. No.: 14/526,753

(22) Filed: Oct. 29, 2014

Related U.S. Application Data
(63) Continuation of application No. PCT/CN2014/074727, filed on Apr. 3, 2014.

(51) Int. Cl. H04H 20/57; H04B 7/26; A24F 47/00

(52) U.S. Cl. CPC H04H 20/57; A24F 47/008; H04B 7/26

(57) ABSTRACT

An information interaction method and system for electronic cigarettes is provided in the present invention; the method comprises the following steps: at least one of the electronic cigarettes sending broadcast information containing electronic cigarette information of the one electronic cigarette to one or more of the other electronic cigarettes, and/or sending request information containing obtaining request for electronic cigarette information to one or more of the other electronic cigarettes, and/or sending response information which is generated to response request information; at least one of the electronic cigarettes receiving broadcast information, requesting information or responding information from one or more of the other electronic cigarettes. When implementing the present invention, the following advantageous effects can be achieved: it is convenient for users to exchange electronic cigarettes information and establish social intercourse; users can be helped to choose suitable electronic cigarettes for themselves; the uses can obtain security guarantee.

### CROSS-REFERENCE TO RELATED APPLICATION

This application is a continuation application of International Patent Application No. PCT/CN2014/074727, by Xiang, Zhiyong, filed Apr. 3, 2014, which are hereby incorporated herein in their entireties by reference.

### FIELD OF THE INVENTION

The present invention relates to the field of electronic cigarettes, more specifically, relates to an information interaction method and system for electronic cigarettes.

### BACKGROUND OF THE INVENTION

An electronic cigarette comprises a battery assembly and an atomizer assembly. The electronic cigarette can heat and atomize tobacco tar, and is provided to smokers as a substitute of cigarettes.

At present, conventional electronic cigarettes can only substitute cigarettes to meet users' smoking demands, but have no communication capability such as information interaction while smoking. Thus, the conventional electronic cigarettes have poor user experience. Furthermore, since the conventional electronic cigarettes have no capability of communicating with each other, the users of the electronic cigarettes can't share electronic cigarette information with each other, and can't choose better and suitable electronic cigarettes according to the guides of other users' choices, either.

Additionally, the conventional electronic cigarettes can't communicate with each other when emergency occurs, and thus can't provide security for users.

Therefore, the existing technology has deficiencies and needs to be improved.

### BRIEF SUMMARY OF THE INVENTION

To solve the drawbacks that conventional electronic cigarettes have no communication capability while smoking, the present invention provides an information interaction method and system for electronic cigarettes.

The technical solutions of the present invention for solving the technical problems are as follows:

An information interaction method for electronic cigarettes, wherein, the method uses at least two electronic cigarettes to interact information, and said method comprises the following steps:

S1. information sending step: at least one of the electronic cigarettes sending broadcast information containing electronic cigarette information of the at least one electronic cigarette to one or more of the other electronic cigarettes, and/or sending request information containing obtaining request for electronic cigarette information to one or more of the other electronic cigarettes, and/or sending response information which is generated to response request information received from one or more of the other electronic cigarettes;

S2. information receiving step: at least one of the electronic cigarettes receiving broadcast information containing electronic cigarette information of one or more of the other electronic cigarettes from one or more of the other electronic cigarettes, and/or receiving request information containing obtaining request for electronic cigarette information from one or more of the other electronic cigarettes, and/or receiving response information from one or more of the other electronic cigarettes which is/are requested.

Advantageously, said method further comprises:

S3. information processing step: at least one of the electronic cigarettes implementing at least one of the following operations when receiving the broadcast information or the response information: storing the obtained electronic cigarette information, displaying the obtained electronic cigarette information, outputting prompt information based on the obtained electronic cigarette information, and retransmitting the obtained electronic cigarette information.

Advantageously, said method further comprises:

after receiving the response information and obtaining the electronic cigarette information, the electronic cigarette sending the request information executing a statistical treatment for the obtained electronic cigarette information, and the result of the statistical treatment is further processed by any one of the following operations: storing the result, displaying the result, retransmitting the result, and outputting prompt information based on the result.

Advantageously, the request information, the broadcast information, or the response information is sent when the electronic cigarette is triggered and generates a trigger signal.

Advantageously, the trigger signal generated by the triggered electronic cigarette and used to start the information sending step is a smoking signal; and

wherein, in a preset time, the type of the electronic cigarette information contained in the broadcast information and the request information varies with the number of the smoking signal used as the trigger signal.

Advantageously, the trigger signal generated by the triggered electronic cigarette and used to start the information sending step is a key inputting signal; and

Wherein, the type of the electronic cigarette information contained in the request information and the broadcast information varies with the key inputting signal.

Advantageously, the type of the electronic cigarette information comprises at least one of the follows: electronic cigarette type, electronic cigarette battery capacity, type of the charger suitable for the electronic cigarette, manufacturer information of the electronic cigarette, manufacturing country of the electronic cigarette, user information, tobacco tar taste information, and user assessing information for the electronic cigarette.

Advantageously, the electronic cigarette for information interaction stores the electronic cigarette information of itself, or obtains the electronic cigarette information of itself by detection.

Advantageously, the format of the request information comprises: a header code field, an identification code field, a data field, and a check code field;

wherein, the data field is used to identify the type of the electronic cigarette information which is requested to obtain by the request information.

Advantageously, each of the format of the broadcast information and the format of the response information comprises: a header code field, an identification code field, a data field and a check code field;

the data field is used to identify the type of the electronic cigarette information and the electronic cigarette information corresponds to the identified type.

Advantageously, each of the electronic cigarettes has its own ID and each of the electronic cigarettes stores its own ID and the IDs of the other electronic cigarettes;

when the electronic cigarette sends the broadcast information, its own ID is added in the broadcast information;

when the electronic cigarette sends the request information or the response information, its own ID and the ID of the electronic cigarette receiving the request information or the response information are added in the request information or the response information.

Advantageously, when the electronic cigarette is triggered and generates the emergency trigger signal, the electronic cigarette sends an emergency call signal to one or more of the other electronic cigarettes.

Advantageously, a communication range of each of the electronic cigarettes for information interaction is within 3 km.

An information interaction system for electronic cigarettes, wherein, said system comprises at least two electronic cigarettes, and each of the electronic cigarettes comprises an information sending module and an information receiving module;

the information sending module is configured to send broadcast information containing electronic cigarette information of the electronic cigarette to one or more of the other electronic cigarettes, and/or send request information containing obtaining request for electronic cigarette information to one or more of the other electronic cigarettes, and/or send response information which is generated to response request information received from one or more of the other electronic cigarettes;

the information receiving module is configured to receive broadcast information containing electronic cigarette information of one or more of the electronic cigarette from one or more of the other electronic cigarettes, and/or receive request information containing obtaining request for electronic cigarette information from one or more of the other electronic cigarettes, and/or receive response information from one or more of the other electronic cigarettes which is/are requested.

Advantageously, each of the electronic cigarettes further comprises a microprocessor, a display module, a storage module, and a prompt module;

the microprocessor is configured to implement at least one of the following operations when receiving the broadcast information or the response information: storing the obtained electronic cigarette information in the storage module, controlling the display module to display the obtained electronic cigarette information, controlling the prompt module to output prompt information based on the obtained electronic cigarette information, and controlling the information sending module to retransmit the obtained electronic cigarette information.

Advantageously, each of the electronic cigarettes of said system further comprises a smoking sensor;

the smoking sensor is configured to receive a smoking signal and send the smoking signal to the microprocessor; and

the microprocessor controls the information sending module to send information and/or controls the information receiving module to receive information based on the received smoking signal.

When implementing the information interaction method and system for electronic cigarettes of the present invention, the following advantageous effects can be achieved: the electronic cigarette has radio communication capability in a small area, and can exchange information with another electronic cigarette having radio communication capability in a small area. In this way, it is convenient for users to exchange information with each other, so that the electronic cigarettes are not only used as cigarettes, but also become bridges for communication between users. By statistical treatment for the electronic cigarettes information, the users can be helped to choose better and suitable electronic cigarettes for themselves. The users of the electronic cigarettes can easily establish social intercourse with each other, which is beneficial for communication between the users, and is further beneficial for the users to quit smoke. Additionally, the users can make emergency calls by the electronic cigarettes, so that the users can obtain security guarantee. In conclusion, the user experience can be improved.

### BRIEF DESCRIPTION OF THE DRAWINGS

The present invention will be further described with reference to the accompanying drawings and embodiments in the following, in the accompanying

### DRAWINGS

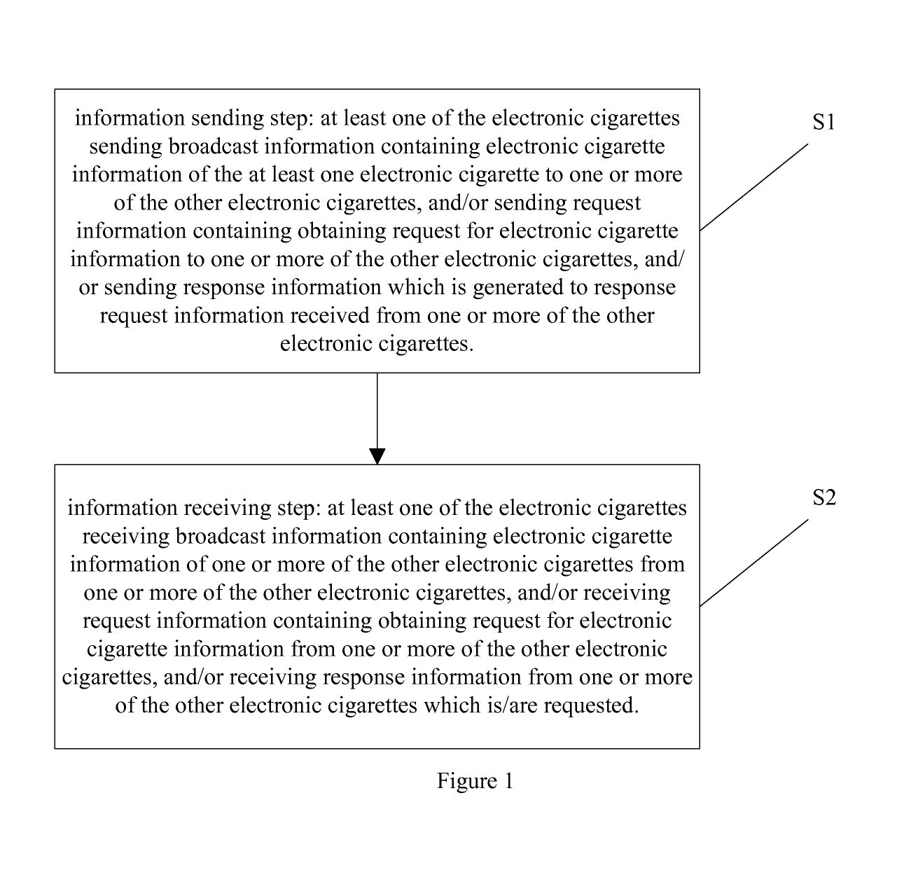

FIG. 1 is a flow chart of an information interaction method for electronic cigarettes in accordance with an embodiment of the present invention;

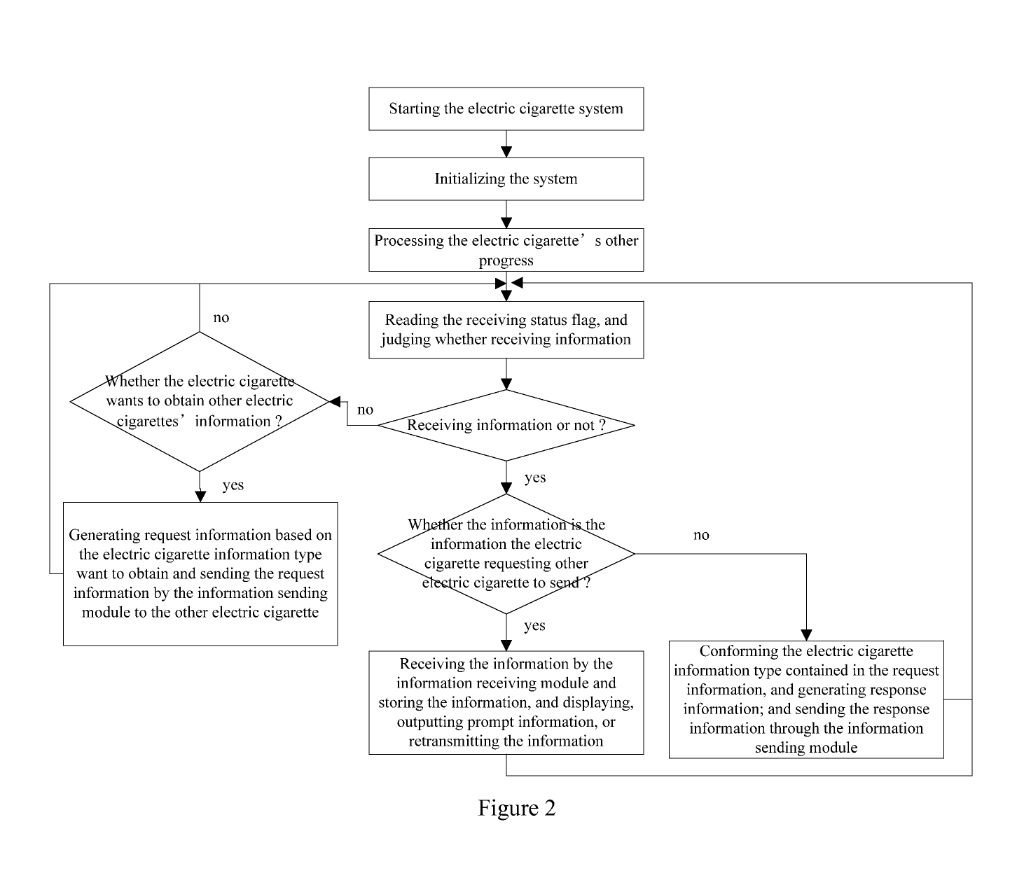

FIG. 2 is a flow chart of automatically sending and receiving information using an electronic cigarette in accordance with an embodiment of the present invention;

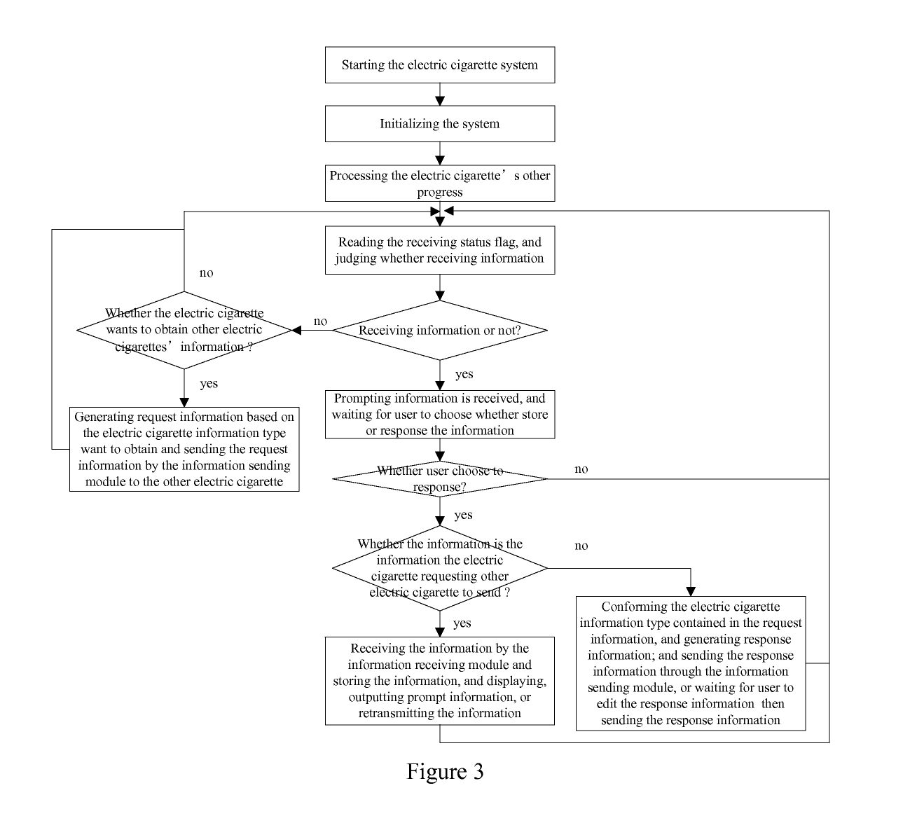

FIG. 3 is a flow chart of manually sending and receiving information using an electronic cigarette, in accordance with an embodiment of the present invention;

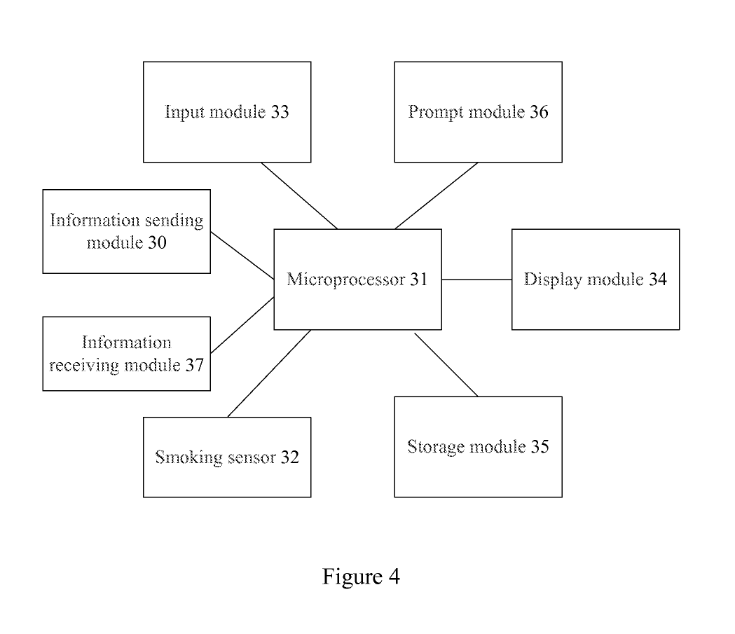

FIG. 4 is a block diagram of an electronic cigarette, in accordance with an embodiment of the present invention;

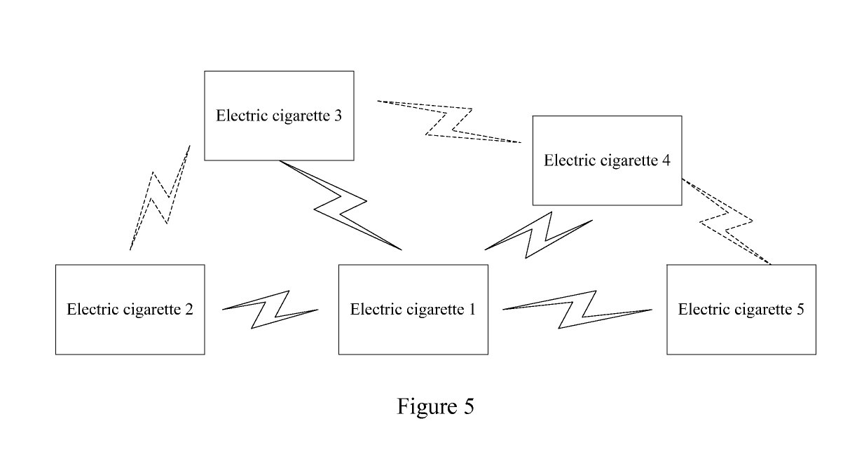

FIG. 5 is a connection relation diagram of electronic cigarettes in the information interaction system for electronic cigarettes, in accordance with an embodiment of the present invention.

### DETAILED DESCRIPTION OF THE PREFERRED EMBODIMENT

To make the technical schemes, objects and advantages more clearly, the embodiments of the present invention may be further described in detail with reference to the accompanying drawings.

In one embodiment of the information interaction method for electronic cigarettes of the present invention, at least two communicatively connected electronic cigarettes are used to exchange electronic cigarette information and thereby achieve the interaction of the electronic cigarette information between the electronic cigarettes. By statistical treatment for the electronic cigarette information, users can be helped to choose better and suitable electronic cigarettes. Besides, the users of the electronic cigarettes can easily establish social intercourse with each other, which is beneficial for communication between the users, and is further beneficial for the uses to quit smoke, and so on.

In the embodiment of the present invention, each of the electronic cigarettes comprises an information sending module and an information receiving module which use radio frequency communication technology, for example, WIFI, Bluetooth, and so on, to communicate. The frequency of the radio frequency communication can be 315 MHz, 433 MHz, 900 MHz, and so on. The information sending module and the information receiving module can also use other communication technologies, for example, optical communication technology, to communicate.

See FIG. 1, which is a flow chart of an information interaction method for electronic cigarettes in accordance with an embodiment of the present invention.

In accordance with this embodiment of the present invention, the information interaction method is used to enable at least two electronic cigarettes to exchange information within a communication range (i.e., an available communication range of the information sending module and the information receiving module of the electronic cigarette, for example, in this embodiment, the communication range can be within 3 km). In accordance with this embodiment of the present invention, the information interaction method comprises the following steps:

S1, information sending step: at least one of the electronic cigarettes sending broadcast information containing electronic cigarette information of the at least one electronic cigarette to one or more of the other electronic cigarettes, and/or sending request information containing obtaining request for electronic cigarette information to one or more of the other electronic cigarettes, and/or sending response information which is generated to response request information received from one or more of the other electronic cigarettes.

S2, information receiving step: at least one of the electronic cigarettes receiving broadcast information containing electronic cigarette information of one or more of the other electronic cigarettes from one or more of the other electronic cigarettes, and/or receiving request information containing obtaining request for electronic cigarette information from one or more of the other electronic cigarettes, and/or receiving response information from one or more of the other electronic cigarettes which is/are requested.

The method of the present invention further comprises:

S3, information processing step: at least one of the electronic cigarettes implements at least one of the following operations when receiving the broadcast information or the response information: storing the obtained electronic cigarette information, displaying the obtained electronic cigarette information, outputting prompt information based on the obtained electronic cigarette information, and retransmitting the obtained electronic cigarette information.

The method of the present invention further comprises: after receiving the response information and obtaining the electronic cigarette information, the electronic cigarette sending the request information executing a statistical treatment for the obtained electronic cigarette information, and the result of the statistical treatment is further processed by any one of the following operations: storing the result, displaying the result, retransmitting the result, and outputting prompt information based on the result.

In particular, the type of the electronic cigarette information comprises at least one of the follows: electronic cigarette type, electronic cigarette battery capacity, type of the charger suitable for the electronic cigarette, manufacturer's information of the electronic cigarette, manufacturing country of the electronic cigarette, user information, tobacco tar taste information, and user assessing information for the electronic cigarette. Each type of electronic cigarette information corresponds to specific electronic cigarette information. For example, to electronic cigarette A, the type of the electronic cigarette information of “electronic cigarette type” corresponds to the electronic cigarette information of “type 1”, and “manufacturing country of the electronic cigarette” corresponds to the specific electronic cigarette information of “China”. The electronic cigarette information corresponds to the user information comprises at least one of the follows: name, contact information, interests, and occupation. In this embodiment of the present invention, the electronic cigarette stores the electronic cigarette information of itself. Besides, in this embodiment of the present invention, the electronic cigarette can also obtain the electronic cigarette information of itself by detection. For example, a conventional tobacco tar taste information detecting chip can be used to detect the tobacco tar to obtain the tobacco tar taste information of the electronic cigarette itself. Thus, although the tobacco tar taste information isn't stored in the electronic cigarette, when the electronic cigarette needs to exchange the tobacco tar taste information, the tobacco tar taste information can be obtained by real-time detecting, so that the electronic cigarette can interact with other electronic cigarettes using the tobacco tar taste information. It should be understood that the user information, the user assessing information for the electronic cigarette, and so on can also be generated by real-time detection. For example, when information interaction is needed, the aforementioned information can be input through the input module of the electronic cigarette by user, so that the electronic cigarette can obtain the information and perform the information interaction.

In this embodiment of the present invention, the format of the request information comprises: a header code field, an identification code field, a data field, and a check code field. Wherein, the data field is used to identify the type of the electronic cigarette information which is requested to obtain by the request information. Each of the format of the broadcast information and the format of the response information comprises: a header code field, an identification code field, a data field, and a check code field. Wherein, the data field is used to identify the type of the electronic cigarette information and the electronic cigarette information corresponds to the identified type.

See FIG. 2, in this embodiment of the present invention, the electronic cigarette can be set as an automatically receiving information mode (that is, the electronic cigarette receives information automatically when any other electronic cigarette in the communication range sends request information or broadcast information) and an automatically sending information mode (that is, the electronic cigarette sends response information automatically after receiving request information). Furthermore, see FIG. 3, in this embodiment of the present invention, the electronic cigarette can also be set as a manually receiving information mode and a manually sending information mode. In the manually receiving information mode, the electronic cigarette outputs prompt information (such as a voice prompting, a display prompting, and so on) when receiving request information or broadcast information from any other electronic cigarette in the communication range. If the user chooses to receive the information, the electronic cigarette receives the information; otherwise the electronic cigarette doesn't receive the information. In the manually sending information mode, when the electronic cigarette needs to send information to other electronic cigarettes, the information is sent after the electronic cigarette is trigged by the user. That is, the request information, the broadcast information, or the response information will be sent when the electronic cigarette is triggered and generates a trigger signal.

In this embodiment of the present invention, the trigger signal configured for sending information is generated by the user's triggering. The user's trigger mode can be triggering a key input signal by an input module of the electronic cigarette (such as a key, a touch screen, and so on) or generating a smoking signal by a smoking sensor of the electronic cigarette. Wherein, the types of the electronic cigarette information contained in the data field of the broadcast information and the request information vary with the number of the smoking signal. The types of the electronic cigarette information contained in the data field of the broadcast information and the request information also vary with the key inputting signal.

Specifically, the corresponding relationship between the number of the smoking signal and the type of the electronic cigarette information contained in the data field of the request information or the broadcast information can be set as the following method: if the electronic cigarette is triggered and generates the smoking signal once, the type of the electronic cigarette information corresponds to the electronic cigarette type; if the electronic cigarette is triggered and generates the smoking signal twice, the type of the electronic cigarette information corresponds to the electronic cigarette battery capacity; if the electronic cigarette is triggered and generates the smoking signal three times, the type of the electronic cigarette information corresponds to the type of the charger suitable for the electronic cigarette; if the electronic cigarette is triggered and generates the smoking signal four times, the type of the electronic cigarette information corresponds to the manufacturer's information of the electronic cigarette; if the electronic cigarette is triggered and generates the smoking signal five times, the type of the electronic cigarette information corresponds to the manufacturing country of the electronic cigarette; if the electronic cigarette is triggered and generates the smoking signal six times, the type of the electronic cigarette information corresponds to the user information; if the electronic cigarette is triggered and generates the smoking signal seven times, the type of the electronic cigarette information corresponds to the tobacco tar taste information; and if the electronic cigarette is triggered and generates the smoking signal eight times, the type of the electronic cigarette information corresponds to the user assessing information for the electronic cigarette. The number of the smoking signal is obtained by a conventional smoking sensor and a conventional microprocessor in the electronic cigarette. In this way, when the user needs to obtain electronic cigarette information of other electronic cigarettes, he/she can achieve this object by smoking. It is convenient for users, and the users experience can be improved.

It should be understood that, in this embodiment of the present invention, the input module of the electronic cigarette can be combined with the inputting mode to distinguish the trigger signal for the request information or the broadcast information from the user's normal smoking signal. For example, if the input module is a key, a smoking signal triggered by smoking after keeping pressing the key for 5 seconds is identified as the smoking signal that triggers the request information or the broadcast information and sent. Otherwise, the smoking signal is identified as the normal smoking signal. In addition, other methods also can be chosen. For example, a smoking signal triggered by a long smoking operation that makes the smoking signal last for ten seconds is identified as the smoking signal that triggers the request information or the broadcast information and sent. It should be understood that any other ways can be chosen to implement the distinguishment.

In this embodiment of the present invention, if the input module of the electronic cigarette is a key, the corresponding relationship between the key inputting signal and the type of the electronic cigarette information contained in the data field of the request information or the broadcast information can be set as the following method: if the key is pressed once, the type of the electronic cigarette information corresponds to the electronic cigarette type; if the key is pressed twice, the type of the electronic cigarette information corresponds to the electronic cigarette battery capacity; if the key is pressed three times, the type of the electronic cigarette information corresponds to the type of the charger suitable for the electronic cigarette; if the key is pressed four times, the type of the electronic cigarette information corresponds to the manufacturer's information of the electronic cigarette; if the key is pressed five times, the type of the electronic cigarette information corresponds to the manufacturing country of the electronic cigarette; if the key is pressed six times, the type of the electronic cigarette information corresponds to the user information; if the key is pressed seven times, the type of the electronic cigarette information corresponds to the tobacco tar taste information; and if the key is pressed eight times, the type of the electronic cigarette information corresponds to the user assessing information for the electronic cigarette.

If the input module is a touch input module or a key input module, the user can input the type of the electronic cigarette information directly (i.e., being similar to the input mode of conventional mobile phones).

It should be understood that, if the electronic cigarette responds the response information after receiving the request information, it does not need to set the electronic cigarette information type according to above methods. The electronic cigarette can respond the response information by obtaining the type of the electronic cigarette information requested to obtain by the request information. It should also be understood that, although the electronic cigarette information type does not need to be set by above methods, the response information can also be responded by above manual mode or automatic mode.

In this embodiment of the present invention, in order to prevent harassment information, the electronic cigarette can shut down communication connection to avoid receiving request information or response information from other electronic cigarettes.

In this embodiment of the present invention, hexadecimal is used for setting the electronic cigarette information type. In particular, “0X01”, “0X02”, “0X03”, “0X04”, “0X05”, “0X06”, “0X07” and “0X08” are used to correspond to the electronic cigarette type, the electronic cigarette battery capacity, the type of the charger suitable for the electronic cigarette, the manufacturer's information of the electronic cigarette, the manufacturing country of the electronic cigarette, the user information, the tobacco tar taste information, and the user assessing information for the electronic cigarette, respectively.

In this embodiment of the present invention, hexadecimal is also used for identifying the specific electronic cigarette information contained by the type of the electronic cigarette information. For example, to the electronic cigarette type, if the specific electronic cigarette information corresponding to the electronic cigarette type includes: type 1, type 2, and type 3, “0X01”, “0X02” and “0X03” are used for identifying the type 1, type 2, and type 3, respectively. In another example, to the manufacturing country of the electronic cigarette, if the specific electronic cigarette information corresponding to the manufacturing country of the electronic cigarette includes: China, American, and Germany, “0X01”, “0X02” and “0X03” are used to identify China, American, and Germany, respectively. Other types of electronic cigarette information are identified according to similar methods, and thus a table 1, which shows the corresponding relationship between the electronic cigarette information types and the specific electronic cigarette information corresponding to the types, is established. In this embodiment of the present invention, the electronic cigarette can store the table 1.

TABLE 1

| | | Hexadecimal |
|---|---|---|
| | | identification |
| | The electronic | corresponding to |
| The type of the electronic | cigarette | the electronic |
| cigarette information | information | cigarette information |
| Electronic cigarette type | Type 1 | 0X01 |
| | Type 2 | 0X02 |
| | Type 3 | 0X03 |
| Electronic cigarette battery | 650mah | 0X01 |
| capacity | 1000mah | 0X02 |
| Type of the charger suitable | Charger Type 1 | 0X01 |
| for the electronic cigarette | Charger Type 2 | 0X02 |
| Manufacturer's information | Manufacturer 1 | 0X01 |
| of the electronic cigarette | Manufacturer 2 | 0X02 |
| | Manufacturer 3 | 0X03 |
| Manufacturing country of the | China | 0X01 |
| electronic cigarette | American | 0X02 |
| | Japan | 0X03 |
| Tobacco tar taste information | Taste 1 | 0X01 |
| | Taste 2 | 0X02 |
| User assessing information | Excellent | 0X01 |
| for the electronic cigarette | Common | 0X02 |

Each of the format of the request information, the format of the broadcast information, and the format of the response information sent by the electronic cigarette comprises: a header code field, an identification code field, a data field, and a check code field. Wherein, the size of the header code field is 1 byte, for example, the header code field can be set as “0X55”. The size of the identification code field is 1 byte, and the identification code field is used to identify the information sent by the electronic cigarette as request information, broadcast information, or response information. The identifying method can be as follows: if the sent information is request information, the identification code field is “0X65”; if the sent information is broadcast information, the identification code field is “0X60”; and if the sent information is response information, the identification code field is “0X9A”. The size of the check code field is 1 byte or 2 bytes, and the check code field is used to check information. In particular, the checking method can be the checksum mode or the CRC checksum cycle mode. The size of the data field can be adjusted according to real situation.

If the identification code field identifies the information sent by the electronic cigarette as request information, the electronic cigarette information contained in the data field is a request for obtaining the electronic cigarette information. The electronic cigarette information obtaining request contains the type of the electronic cigarette information which is requested to obtain. For example, if the data field is “0X01”, it can be inferred that the request information sent by the electronic cigarette is used to request and obtain “electronic cigarette type” of the other electronic cigarettes, and the response information sent from the other electronic cigarettes should contain type information of the other electronic cigarettes. If the data field is “0X02”, it can be inferred that the request information is used to request “electronic cigarette battery capacity”, and so on.

If the identification code field identifies the information sent by the electronic cigarette as response information or broadcast information, the data field contains the electronic cigarette information type and the electronic cigarette information corresponding to the type. The electronic cigarette information in the response information corresponds to the type of the electronic cigarette information in the request for obtaining the electronic cigarette information. For example, if the data field of the received request information is “0X01”, the data field of the response information is “0X01 0X01”, which indicates that the electronic cigarette type is “0X01”.

In this embodiment of the present invention, if the user information is contained in the response information or the broadcast information, the user information is coded by GB2312 location code to form the data field, and further generate the response information or the broadcast information.

Furthermore, in the embodiment of the present invention, hexadecimal can be replaced by binary system, decimal system, and so on.

Table 1 and a specific embodiment are combined to explain the information interaction method for electronic cigarettes of the embodiment of the present invention in detail as follows:

Assuming five electronic cigarettes are communicatively connected together for interacting information. An electronic cigarette A and an electronic cigarette B are two of the five electronic cigarettes. If the electronic cigarette A needs to send request information containing request for obtaining “electronic cigarette type” to the electronic cigarette B, and the type of the electronic cigarette B is type 2, the electronic cigarette A can obtain the type of the electronic cigarette B by the following three modes:

Mode 1: when the electronic cigarette A is triggered and generates a trigger signal which is used for sending information, the electronic cigarette A generates request information and sends the request information to the other four electronic cigarettes by broadcast. The request information is illustrated as follows:

| 0X55 | 0X65 | 0X01 | 0X3B |
|---|---|---|---|
| Header | Identification | Data | Check |
| code | code | | code |

The electronic cigarette B receives and decodes the request information. As “0X65” indicates that the received information is request information and “0X01” indicates that “electronic cigarette type”, the electronic cigarette B generates response information according to stored electronic cigarette type of itself (assuming that the type of the electronic cigarette B is type 2). The response information is illustrated as follows:

| 0X55 | 0X9A | 0X01 0X02 | 0XF5 |
|---|---|---|---|
| Header | Identification | Data | Check |
| code | code | | code |

The electronic cigarette B sends the response information to the other four electronic cigarettes by broadcast, and thus the electronic cigarette A can receive the response information and obtain the type of the electronic cigarette B.

Mode 2: Each of the five electronic cigarettes has its own ID (Identity, which is an identification number), and each of the five electronic cigarettes stores the ID of itself and the IDs of the other electronic cigarettes. The electronic cigarette A sends communication request based on the ID of the electronic cigarette B to the electronic cigarette B. The electronic cigarette B builds communication connection with the electronic cigarette A upon receiving the communication request. While the communication connection is built, the electronic cigarette A only sends the request information (as shown in the above mode 1) to the electronic cigarette B, and the electronic cigarette B only sends the response information (as shown in the above mode 1) to the electronic cigarette A.

Mode 3: Each of the five electronic cigarettes has its own ID, and each of the five electronic cigarettes stores the ID of itself and the IDs of the other electronic cigarettes. When the electronic cigarette A generates request information and sends the request information to the other four electronic cigarettes by broadcast, the electronic cigarette A adds the ID of itself and the ID of the electronic cigarette B into the request information. Thus, the request information is illustrated as follows:

| 0X55 | 0X65 | 0X01 | 0XAAAAAAAA | 0XBBBBBBBB | 0X0752 |
|---|---|---|---|---|---|
| Header | Identification | Data | The ID information of | The ID information of | Check |
| code | code | | the electric cigarette A | the electric cigarette B | code |

The electronic cigarette B receives and decodes the request information. The electronic cigarette B further generates response information as follows:

| 0X55 | 0X9A | 0X01 | 0XBBBBBBBB | 0XAAAAAAAA | 0X0689 |
|---|---|---|---|---|---|
| Header | Identification | Data | The ID information of | The ID information of | Check |
| code | code | | the electric cigarette B | the electric cigarette A | code |

In this way, the electronic cigarette A can receive the response information and obtain the type of the electronic cigarette B.

By the above three modes, the electronic cigarette A decodes the received response information and obtains the “electronic cigarette type” of the electronic cigarette B, which is “type 2”. Thus, the electronic cigarette A can further implement other operations such as storing, displaying, and so on, and can also retransmit the type of the electronic cigarette B or compare the “electronic cigarette type” of the electronic cigarette B with the “electronic cigarette type” of the electronic cigarette A. If the two types are same, the electronic cigarette A can output prompt information.

It should be understood that, if the electronic cigarette A needs to obtain the “electronic cigarette type” of a plurality of (e.g., two, three and so on) electronic cigarettes, the request information can be sent by broadcasts. Advantageously, in order to ensure that all of the plurality of electronic cigarettes reply response information to the electronic cigarette A, the mode 2, which makes the electronic cigarette A build real-time communication connections with the plurality of electronic cigarettes respectively, can be chosen. Furthermore, the mode 3 can be chosen too. By the mode 3, different ID information of the plurality of electronic cigarettes is added into different request information respectively, and many pieces of request information are sent respectively to ensure that each of the plurality of electronic cigarettes replies corresponding response information.

In this embodiment of the present invention, if the electronic cigarette A obtains the electronic cigarette information (such as the information of “the electronic cigarette type”) of the plurality of other electronic cigarettes, a statistical treatment can be implemented by the electronic cigarette A. The statistical treatment comprises: the electronic cigarette A counts similar information of the obtained information, and then stores the counting results, displays the counting results, retransmits the counting results, or prompts the user of the electronic cigarette A based on the counting results. For example, if the electronic cigarette A obtains “the electronic cigarette type” information of four electronic cigarettes, the electronic cigarette A counts the number of type 1, the number of type 2, and the number of type 3 respectively. The number of each type can be displayed in order. In this way, the user can know which “electronic cigarette type” is used by more users, and the user can be helped to choose the electronic cigarette type.

In this embodiment of the present invention, the implementation principle of other kinds of information interaction (e.g., electronic cigarette battery capacity, type of the charger suitable for the electronic cigarette, manufacturer's information of the electronic cigarette, manufacturing country of the electronic cigarette, user information, tobacco tar taste information, and user assessing information for the electronic cigarette) between the electronic cigarettes is the same as above implementation principle of the “electronic cigarette type” interaction, and the implementation principle of other kinds of information interaction do not need to be repeated here.

In this embodiment of the present invention, the information interaction method for electronic cigarettes also can be used to realize emergency call, and the implementation is detailed as follows:

When the electronic cigarette is triggered and generates an emergency trigger signal, it sends an emergency call signal to one or more of the other electronic cigarettes. The emergency call signal contains a field for identifying emergency call. For example, the identification code field in the aforementioned request information can be set as “0X10”, and the data field in the request information can be set as “0X00”. When any of the other electronic cigarettes receives and decodes this request information, this request information can be identified as an emergency call signal. Thus, the electronic cigarette receiving the emergency call signal can output prompt information to prompt its user (e.g., displaying “SOS” by the display module of the electronic cigarette and triggering alarm). In this way, the user can be informed that someone around needs emergency helping and help him/her timely.

In this embodiment of the present invention, the emergency trigger signal is generated by an emergency button. The emergency button can be a separate key, and can also be integrated with an input module of the electronic cigarette (such as a keypad, a touch screen, etc.). When the emergency button is integrated with the input module, the trigger mode of the input module can be preset. For example, the trigger mode can be set as triggering the electronic cigarette to send the emergency helping signal by pressing the input module for ten seconds or consecutively inputting five times.

Therefore, by using the information interaction method for electronic cigarettes in the embodiment of the present invention, when a user encounters an emergency situation such as emergent serious illness (e.g., heart disease, faint, and so on), the electronic cigarette can be used to send emergency call signals to users of ambient electronic cigarettes to call for help. In this way, the users can obtain security guarantee.

In the embodiment of the present invention, the methods for implementing the information interaction between the electronic cigarettes comprise: (1) an electronic cigarette sends request information (e.g., sending by broadcast mode, one-to-one mode, or one-to-many mode), and at least one electronic cigarette receiving the request information sends response information (e.g., sending by broadcast mode, one-to-one mode, or one-to-many mode); (2) the electronic cigarette actively sends broadcast information to other electronic cigarettes (e.g., sending by broadcast mode, one-to-one mode, or one-to-many mode). The methods for implementing the information interaction between the electronic cigarettes comprise broadcast mode, one-to-one mode, one-to-many mode, and so on. In the one-to-one mode, two electronic cigarettes that need to exchange information can establish communication connection at first, and then implement information interaction.

In this embodiment of the present invention of the information interaction method for electronic cigarettes, the request information or the response information sent by the electronic cigarettes can be encrypted (wherein, the encryption algorithm can be conventional technology), and electronic cigarettes receiving the information decrypts the information by corresponding decryption algorithm. Thus, the security of information interaction between the electronic cigarettes is enhanced.

See FIG. 4, which is a block diagram of an electronic cigarette in accordance with an embodiment of the present invention. In this embodiment of the present invention, the electronic cigarette mainly comprises: an information sending module 30, an information receiving module 37, a microprocessor 31, a smoking sensor 32, an input module 33, a display module 34, a storage module 35, and a prompt module 36. Besides, the electronic cigarette further comprises an atomizer assembly, a power supplying battery, and so on, which belong to conventional technology and do not need to be detailed here.

The information sending module 30 uses radio-frequency technology or other communication technology to send information. The information receiving module 30 uses radio-frequency technology or other communication technology to receive information. The information sending module 30 and the information receiving module 37 can be WIFI modules, Bluetooth modules, and so on, and can also be modules that use the frequency of 315 MHz, 433 MHz, or 900 MHz to implement radio frequency communication. The microprocessor 31 is a programmable device, such as a single-chip computer. The storage module 35 is used for storing above electronic cigarette information types and electronic cigarette information corresponding to the types. The smoking sensor 32 is a baroceptor or an airflow sensor. The input module 33 is a key input module or a touch screen input module. The display module 34 is a LED lamp or a LCD screen. The storage module 35 is a flash module.

See FIG. 5, which is the connection diagram of electronic cigarettes in an information interaction system for electronic cigarettes in accordance with an embodiment of the present invention. The information interaction system for electronic cigarettes in accordance with the embodiment of the present invention comprises at least two electronic cigarettes. Each of the electronic cigarettes comprises: an information sending module, an information receiving module, a microprocessor, a display module, a storage module, a prompt module, a smoking sensor, an input module, and so on. FIG. 5 shows five electronic cigarettes communicating with each other by their information sending modules and information receiving modules.

The information sending module is configured to send broadcast information containing electronic cigarette information of the electronic cigarette to at least one of the other electronic cigarettes in a pre-set communication range, and/or send request information containing request for obtaining electronic cigarette information to one or more of the other electronic cigarettes in the pre-set communication range, and/or send response information which is generated to response request information received from one or more of the other electronic cigarettes.

The information receiving module is configured to receive broadcast information containing electronic cigarette information of one or more of the electronic cigarette from one or more of the other electronic cigarettes in the pre-set communication range, and/or receive request information containing request for obtaining electronic cigarette information from one or more of the other electronic cigarette in the pre-set communication range, and/or receive response information from one or more of the other electronic cigarettes which is/are requested in the pre-set communication range.

The microprocessor is configured to implement at least one of the following operations when receiving the broadcast information or the response information: storing the obtained electronic cigarette information in the storage module, controlling the display module to display the obtained electronic cigarette information, controlling the prompt module to output prompt information based on the obtained electronic cigarette information, and controlling the information sending module to retransmit the obtained electronic cigarette information.

In this embodiment of the present invention, the first electronic cigarette 1 is assumed to be the electronic cigarette sending request information, and the other electronic cigarettes are the electronic cigarettes receiving the request information. The first electronic cigarette 1 sends the request information by broadcasts, any one or more of the second electronic cigarette to the fifth electronic cigarette receive(s) the request information, and the electronic cigarette(s) that send(s) the response information can be one or more of the electronic cigarettes receiving the request information. Furthermore, the first electronic cigarette 1 can also send the request information to one or more assigned electronic cigarette(s).

Advantageously, in this embodiment of the present invention, the smoking sensor is configured to generate a smoking signal upon sensing smoke and send the smoking signal to the microprocessor. The microprocessor controls the information sending module to send information and/or controls the information receiving module to receive information based on the received smoking signal.

It should be understood that the method for achieving the interaction of the request information, the broadcast information, the response information, and the emergency helping signals between the electronic cigarettes shown in FIG. 5 is the same as the information interaction method described in above embodiments (e.g., as shown in FIG. 1 and FIG. 3).

In this embodiment of the present invention, the electronic cigarette has communication capability, and can exchange information with other electronic cigarettes with communication capability. In this way, it is convenient for users to exchange electronic cigarettes information with each other, so that the electronic cigarettes are not only as cigarettes but also become bridges for communication between users.

In accordance with the information interaction method and system for electronic cigarettes of the embodiments of the present invention, the electronic cigarettes can exchange and obtain electronic cigarette information with each other. By the statistical treatment for the electronic cigarette information, the users can be helped to choose better and suitable electronic cigarettes for themselves. Besides, by the present invention, the users of the electronic cigarettes can easily establish social intercourse with each other, which is beneficial for communication between the users, and is further beneficial for the users to quit smoke. Additionally, the users can make emergency call by the electronic cigarettes, so that the users can obtain security guarantee. In conclusion, the user experience can be improved.

While the present invention has been described with reference to preferred embodiments, however, the present invention is not limited to above-mentioned embodiments, those modifications, improvements and equivalent substitutions, which don't depart from the scope of the spirit and the principle of the present invention, should be included within the scope of the present invention.

What is claimed is:

1. An information interaction method for electronic cigarettes, wherein, the method uses at least two electronic cigarettes to interact information, and said method comprises the following steps:
S1. information sending step: at least one of the electronic cigarettes sending broadcast information containing electronic cigarette information of the at least one electronic cigarette to one or more of the other electronic cigarettes, and/or sending request information containing obtaining request for electronic cigarette information to one or more of the other electronic cigarettes, and/or sending response information which is generated to response request information received from one or more of the other electronic cigarettes;
S2. information receiving step: at least one of the electronic cigarettes receiving broadcast information containing electronic cigarette information of one or more of the other electronic cigarettes from one or more of the other electronic cigarettes, and/or receiving request information containing obtaining request for electronic cigarette information from one or more of the other electronic cigarettes, and/or receiving response information from one or more of the other electronic cigarettes which is/are requested.

2. The information interaction method for electronic cigarettes according to claim 1, wherein, said method further comprises:
S3. information processing step: at least one of the electronic cigarettes implementing at least one of the following operations when receiving the broadcast information or the response information: storing the obtained electronic cigarette information, displaying the obtained electronic cigarette information, outputting prompt information based on the obtained electronic cigarette information, and retransmitting the obtained electronic cigarette information.

3. The information interaction method for electronic cigarettes according to claim 1, wherein, said method further comprises:
after receiving the response information and obtaining the electronic cigarette information, the electronic cigarette sending the request information executing a statistical treatment for the obtained electronic cigarette information, and the result of the statistical treatment is further processed by any one of the following operations: storing the result, displaying the result, retransmitting the result, and outputting prompt information based on the result.

4. The information interaction method for electronic cigarettes according to claim 1, wherein, the request information, the broadcast information, or the response information is sent when the electronic cigarette is triggered and generates a trigger signal.

5. The information interaction method for electronic cigarettes according to claim 4,
wherein, the trigger signal generated by the triggered electronic cigarette and used to start the information sending step is a smoking signal; and
wherein, in a preset time, the type of the electronic cigarette information contained in the broadcast information and the request information varies with the number of the smoking signal used as the trigger signal.

6. The information interaction method for electronic cigarettes according to claim 4,
wherein, the trigger signal generated by the triggered electronic cigarette and used to start the information sending step is a key inputting signal; and
wherein, the type of the electronic cigarette information contained in the request information and the broadcast information varies with the key inputting signal.

7. The information interaction method for electronic cigarettes according to claim 1, wherein, the type of the electronic cigarette information comprises at least one of the follows: electronic cigarette type, electronic cigarette battery capacity, type of the charger suitable for the electronic cigarette, manufacturer information of the electronic cigarette, manufacturing country of the electronic cigarette, user information, tobacco tar taste information, and user assessing information for the electronic cigarette.

8. The information interaction method for electronic cigarettes according to claim 7, wherein, the electronic cigarette for information interaction stores the electronic cigarette information of itself, or obtains the electronic cigarette information of itself by detection.

9. The information interaction method for electronic cigarettes according to claim 1,
wherein, the format of the request information comprises: a header code field, an identification code field, a data field, and a check code field;
wherein, the data field is used to identify the type of the electronic cigarette information which is requested to obtain by the request information.

10. The information interaction method for electronic cigarettes according to claim 1,
wherein, each of the format of the broadcast information and the format of the response information comprises: a header code field, an identification code field, a data field and a check code field;
the data field is used to identify the type of the electronic cigarette information and the electronic cigarette information corresponds to the identified type.

11. The information interaction method for electronic cigarettes according to claim 1,
wherein, each of the electronic cigarettes has its own ID and each of the electronic cigarettes stores its own ID and the IDs of the other electronic cigarettes;
when the electronic cigarette sends the broadcast information, its own ID is added in the broadcast information;
when the electronic cigarette sends the request information or the response information, its own ID and the ID of the electronic cigarette receiving the request information or the response information are added in the request information or the response information.

12. The information interaction method for electronic cigarettes according to claim 1, wherein, when the electronic cigarette is triggered and generates the emergency trigger signal, the electronic cigarette sends an emergency call signal to one or more of the other electronic cigarettes.

13. The information interaction method for electronic cigarettes according to claim 1, wherein, a communication range of each of the electronic cigarettes for information interaction is within 3 km.

14. An information interaction system for electronic cigarettes, wherein, said system comprises at least two electronic cigarettes, and each of the electronic cigarettes comprises an information sending module and an information receiving module;
the information sending module is configured to send broadcast information containing electronic cigarette information of the electronic cigarette to one or more of the other electronic cigarettes, and/or send request information containing obtaining request for electronic cigarette information to one or more of the other electronic cigarettes, and/or send response information which is generated to response request information received from one or more of the other electronic cigarettes;
the information receiving module is configured to receive broadcast information containing electronic cigarette information of one or more of the electronic cigarette from one or more of the other electronic cigarettes, and/or receive request information containing obtaining request for electronic cigarette information from one or more of the other electronic cigarettes, and/or receive response information from one or more of the other electronic cigarettes which is/are requested.

15. The information interaction system for electronic cigarettes according to claim 14, wherein, each of the electronic cigarettes further comprises a microprocessor, a display module, a storage module, and a prompt module;
the microprocessor is configured to implement at least one of the following operations when receiving the broadcast information or the response information: storing the obtained electronic cigarette information in the storage module, controlling the display module to display the obtained electronic cigarette information, controlling the prompt module to output prompt information based on the obtained electronic cigarette information, and controlling the information sending module to retransmit the obtained electronic cigarette information.

16. The information interaction system for electronic cigarettes according to claim 14,
wherein, each of the electronic cigarettes of said system further comprises a smoking sensor;
the smoking sensor is configured to receive a smoking signal and send the smoking signal to the microprocessor; and
the microprocessor controls the information sending module to send information and/or controls the information receiving module to receive information based on the received smoking signal.
